(19) United States
(12) Patent Application Publication
(10) Pub. No.: US 2024/0103457 A1
(43) Pub. Date: Mar. 28, 2024

(54) MACHINE LEARNING-BASED DECISION FRAMEWORK FOR PHYSICAL SYSTEMS

(71) Applicant: International Business Machines Corporation, Armonk, NY (US)

(72) Inventors: Dzung Tien Phan, Pleasantville, NY (US); Lam Minh Nguyen, Ossining, NY (US)

(21) Appl. No.: 17/948,620

(22) Filed: Sep. 20, 2022

(51) Int. Cl. G05B 13/02

(52) U.S. Cl. CPC G05B 13/0265

(57) ABSTRACT

Methods, systems, and computer program products for a decision-improvement framework are provided herein. A computer-implemented method includes obtaining regression functions that predict an output of processes of a physical system based on inputs received at each process; automatically generating one or more constraints and one or more objective functions for a model for the physical system based on the regression functions and a representation of the physical system, where the representation specifies relationships between at least a portion of the processes; identifying a set of parameter values for controlling the physical system based on the model; generating a score, for the set of parameter values, based on a predicted improvement of the physical system relative to historical performance of the physical system; and in response to the generated score satisfying a threshold, causing the physical system to be configured in accordance with the set of parameter values.

### BACKGROUND

The present disclosure generally relates to information technology systems, and more specifically, to techniques for improving information technology systems which represent physical systems. For example, one physical system may be a process manufacturing system that processes bulk resources into other products. Process manufacturing systems are used in various industries, including chemical and petrochemical industries, by way of example only.

### SUMMARY

Embodiments of the present disclosure provide machine learning techniques for a decision-improvement framework for physical systems.

In one illustrative embodiment, a system includes a memory configured to store program instructions, and a processor operatively coupled to the memory to execute the program instructions to obtain a plurality of regression functions that predict an output of a plurality of processes of a physical system based on inputs received at each process. In such an embodiment, one or more constraints and one or more objective functions are automatically generated for a model for the physical system based at least in part on the plurality of regression functions and a representation of the physical system, where the representation specifies relationships between at least a portion of the plurality of processes. A set of parameter values for controlling the physical system based on the model is identified. A score is generated, for the set of parameter values, based on a predicted improvement of the physical system relative to historical performance of the physical system. Also, in response to the generated score satisfying a threshold, the physical system is caused to be configured in accordance with the set of parameter values.

In another illustrative embodiment, a computer program product includes a computer readable storage medium having program instructions embodied therewith. The program instructions are executable by a computing device to cause the computing device to obtain a plurality of regression functions that predict an output of a plurality of processes of a physical system based on inputs received at each process. The computing device is further caused to automatically generate one or more constraints and one or more objective functions for a model for the physical system based at least in part on the plurality of regression functions and a representation of the physical system, where the representation specifies relationships between at least a portion of the plurality of processes. The computing device is caused to identify a set of parameter values for controlling the physical system based on the model. The computing device is also caused to generate a score, for the set of parameter values, based on a predicted improvement of the physical system relative to historical performance of the physical system; and in response to the generated score satisfying a threshold, cause the physical system to be configured in accordance with the set of parameter values.

In another illustrative embodiment, a computer-implemented method includes obtaining a plurality of regression functions that predict an output of a plurality of processes of a physical system based on inputs received at each process. The method includes automatically generating one or more constraints and one or more objective functions for a model for the physical system based at least in part on the plurality of regression functions and a representation of the physical system, where the representation specifies relationships between at least a portion of the plurality of processes. The method includes identifying a set of parameter values for controlling the physical system based on the model. The method also includes generating a score, for the set of parameter values, based on a predicted improvement of the physical system relative to historical performance of the physical system; and in response to the generated score satisfying a threshold, causing the physical system to be configured in accordance with the set of parameter values.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

FIG. 1 is an example of an architecture of a framework in accordance with illustrative embodiments;

FIG. 2 shows a graph representation of a process flow diagram in accordance with an illustrative embodiment;

FIG. 3 shows an example of an adjacency matrix representation in accordance with an illustrative embodiment;

FIG. 4 shows a graph representation of a process flow diagram of a physical system, where two products are associated with a single process in accordance with an illustrative embodiment;

FIG. 5 is a flow diagram illustrating techniques for a decision-improvement framework in accordance with exemplary embodiments; and

FIG. 6 is a diagram illustrating a computing environment in which at least one embodiment of the invention can be implemented.

### DETAILED DESCRIPTION

Manufacturing and process industries often include site-wide networks of complex processes, where each process includes a self-contained set of inputs and outputs. Within a unit process, there can exist a transient relationship between set points, throughput, and quality of the desired output and the resulting flow of waste. The variability in input flows, operational requirements, maintenance, breakdowns, changes in production plans, and the like makes the production process dynamic. Plant-wide management requires the ability to predict the dynamic process behavior and to alter any controls to adhere as closely as possible to the production plan. Manual optimization model generation for set-point prediction is time-consuming, challenging and requires both domain experts and optimization experts.

As used herein, the term “set point” generally refers to a parameter that is used to control the behavior of plants and/or processes of such plants. For example, set points can relate to temperatures, pressures, flow rates, and/or the like.

Some current industry practices include limited use of Artificial Intelligence (AI) to devise an operational strategy. For instance, in the event of an unplanned process breakdown, a plant manager (PM) might use an experience-based or a heuristic-based approach to determine set points that offer the best production rates under the operational constraints levied by the breakdown.

A common feature in conventional processes is the use of nonlinear physical first principles (for example, thermodynamics) models for each process, coupled via flow and material balance equations. Existing work has previously combined physical models and data-driven models. The development of surrogate statistical models for complex processes has been undertaken, but mainly as an experimental design to estimate a response surface model using a detailed process simulator. Some conventional processes have used surrogate models to improve production processes, but this is usually done at the design phase to improve a flowsheet structure or in the context of improving set points for a single process. The conventional processes are not able to rely only on historical sensor data without the use of a plant simulator.

A conventional end-to-end learning method considers only a single process and can handle only specific classes of problems due to solving a two-stage stochastic programming problem. Typical processes assume that the improvement problem (for example, an optimization problem) is convex with respect to control variables. The condition does not hold for many common regression functions such as decision tree regression, deep neural networks, multivariate adaptive regression splines (MARS), and random forests. Some conventional end-to-end learning methods require that a decision-focused learning framework be represented as a linear program or submodular maximization. Since the sensor data for plants come from different temporal resolutions, it is unlikely to build an end-to-end solution for a site-wide improvement problem.

Some techniques can automatically generate improvement models to identify operating set points across a multi-plant system. For example, a graphical representation for a process flow diagram of a plant can be defined, and a network topology of the graphical representation can be encoded to generate an adjacency matrix for the graphical representation. A set of equations can be automatically generated that define the network topology. One or more regression functions can be modeled using a machine learning (ML) platform to predict an output of each process of the plant based on one or more respective inputs for the process. An improvement model can be generated from the one or more regression functions for each node and the adjacency matrix. Set points for each process of the plant can be determined by solving the improvement model.

The graphical representation for the process flow diagram of a particular plant is typically in the form of an acyclic directed graph (for example, a fully connected feed-forward network). Users are typically required to create this graphical representation manually, which can be time-consuming and technically difficult. Such graphical representations also do not support cycles, thereby further complicating the process. Additionally, even though a given prediction model used in such techniques can be generated with a high test accuracy, the prediction model might end up providing a low quality of decision when applied to real data. Quantifying the quality of predictions from such models generally includes interacting with the physical system and/or simulators, which can be time-consuming and, sometimes, impractical.

As discussed in greater detail below, the present disclosure generally relates to systems and computerized methods for a site-wide decision-improvement framework that outputs one or more constraints and one or more objective functions for an improvement model based on regression functions and topology information. Such regression functions, in some embodiments, are generated from an automated ML system for each node including control, observed, and environmental variables. Also, in at least one embodiment, the topology information can be represented as a general directed graph for the physical system, where the general directed graph optionally includes one or more cycles. One or more embodiments can automatically determine a solution quality for the decision-improvement pipeline, and incorporate a feedback mechanism to enhance the improvement model and/or ML models, as discussed in more detail herein.

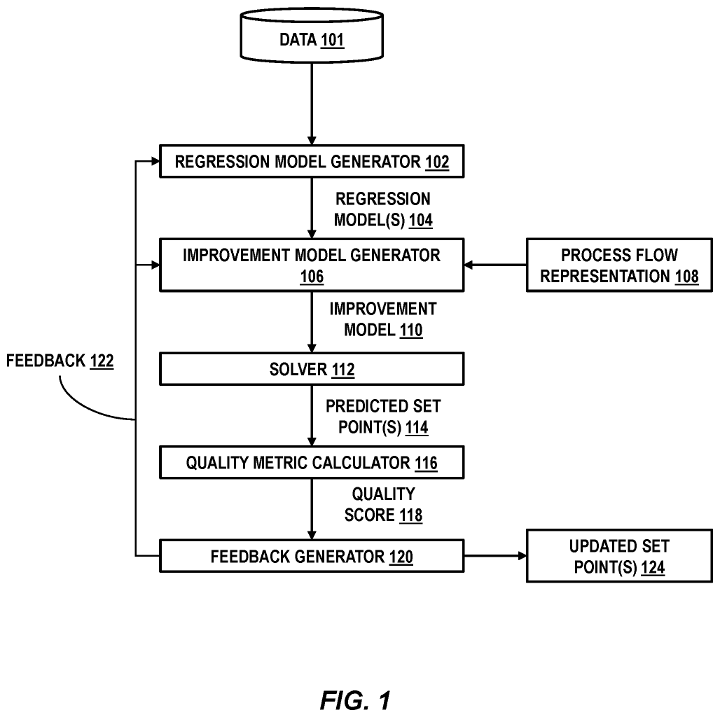

Referring now to FIG. 1, this figure shows an example of an architecture of a decision-improvement framework in accordance with illustrative embodiments. The framework in FIG. 1 includes a regression model generator 102, an improvement model generator 106, a solver 112, a quality metric calculator 116, and a feedback generator 120. Generally, the regression model generator 102 generates one or more regression models 104 by processing historical data 101 related to one or more processes (for example, performed at a given plant) over a period of time. As an example, each regression model 104 can comprise a regression function that describes a process (or plant) of a physical system. For example, each one of the regression models 104 can describe one of a plurality of processes in terms of input and output parameters.

The improvement model generator 106 generates an improvement model 110 based on the regression models 104, a process flow representation 108 of the physical system, and possibly feedback 122 generated by a feedback generator 120. In some embodiments, the improvement model 110 can comprise one or more constraints and one or more objective functions that are automatically generated by the improvement model generator 106, as described in more detail elsewhere herein. In some examples, the improvement model 110 can correspond to an optimization model. The solver 112 generates one or more predicted set points 114 based on the improvement model 110. The quality metric calculator 116 determines a quality score 118 for the predicted set points 114 based on a predicted improvement of the physical system over historical performance. The feedback generator 120, in some embodiments generates feedback 122 based on the quality score 118, and provides the feedback to the regression model generator 102 and/or the improvement model generator 106. In some examples, the feedback generator 120 can compare the quality score 118 to a threshold quality score. If the quality score 118 satisfies the threshold quality score, then the predicted set points 114 can be sent to one or more of the nodes as updated set point(s) 124 for updating a configuration of the physical system. Otherwise, the feedback 122 can be used to update the regression models 104 and/or the improvement model 110, which in turn are used to update the predicted set points 114. This process can be repeated until the quality score 118 satisfies the quality score threshold.

In some examples, the feedback 122 can include the quality score 118, and the regression model generator 102 and/or the improvement model generator 106 can be updated based on the quality score. Alternatively, or additionally, the feedback 122 can include inputs from one or more users (for example, subject matter experts) related to the predicted set points 114 and/or the quality score 118.

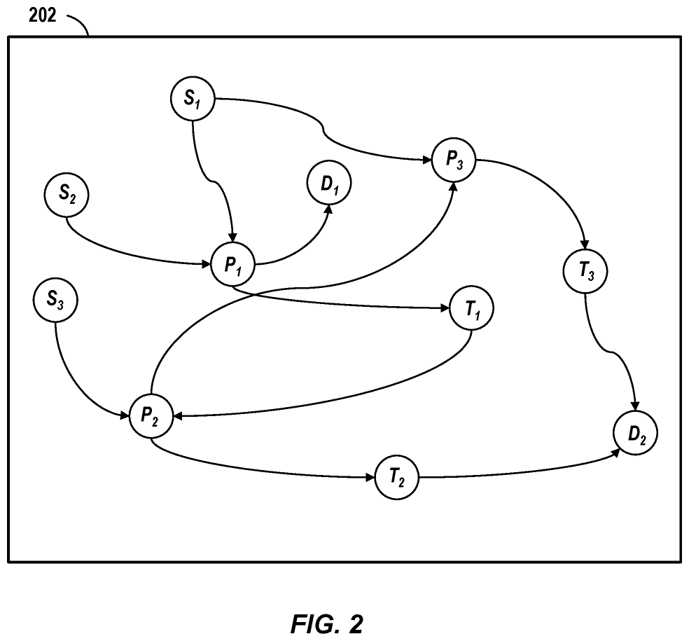

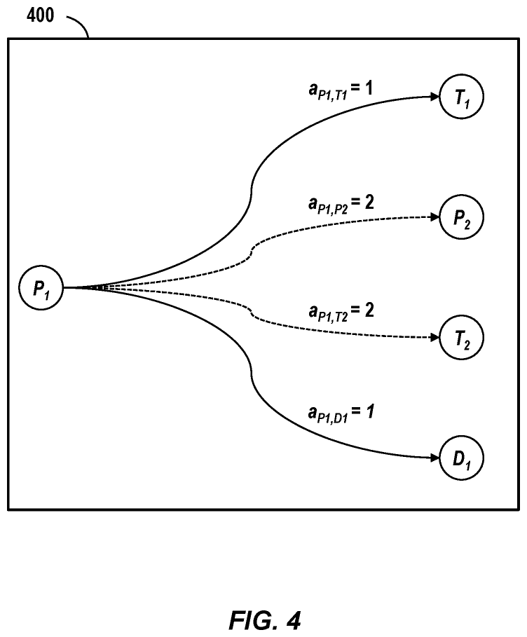

Examples of input schemas that can be used to provide the process flow representation 108 to the improvement model generator 106 are described in further detail in conjunction with FIGS. 2 and 4.

FIG. 2 shows a graph representation 202 of a process flow diagram in accordance with an illustrative embodiment. The graph representation 202 can correspond to the process flow representation 108, for example. In this example, the graph representation 202 includes nodes representing different aspects of a physical system. More specifically, nodes S₁, S₂, and S₃ represent supply nodes, nodes P₁, P₂, and P₃ represent process nodes, nodes T₁, T₂, and T₃ represent tank (or storage) nodes, and nodes D₁ and D₂ represent terminal nodes.

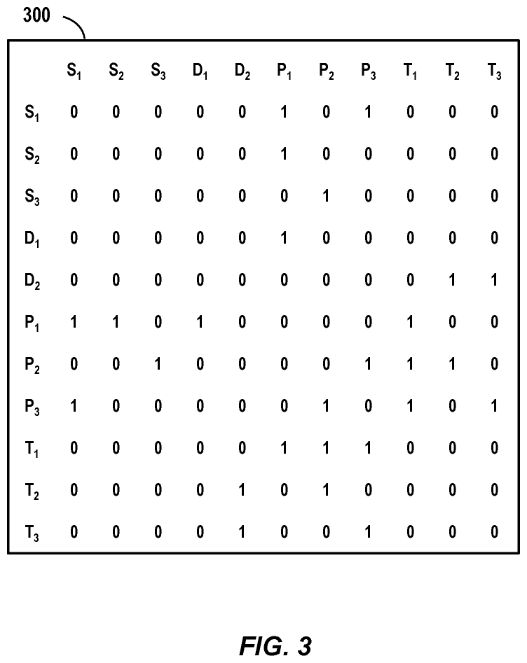

Referring also to FIG. 3, this figure shows an example of an adjacency matrix 300 for the graph representation 202, in accordance with an illustrative embodiment. In this example, the rows and columns of the adjacency matrix 300 are labeled with the nodes shown in the graph representation 202. The adjacency matrix 300 is created by assigning a value of 1 to entries where the corresponding nodes are connected, otherwise the entries are assigned a value of 0.

FIG. 4 shows a graph representation 400 of a process flow diagram of a physical system, where two products are associated with a single process, in accordance with an illustrative embodiment. In particular, the graph representation 400 includes nodes P₁ and P₂ representing process nodes, nodes T₁ and T₂ representing tank nodes, and node D₁ representing a terminal node. The solid arrows in the graph representation 400 correspond to a first product (product 1) and the dashed arrows correspond to a second product (product 2). The graph representation 400 can also be provided as an adjacency matrix, where the connections between nodes associated with product 1 are assigned a value of 1 and the connections between nodes associated with product 2 are assigned a value of 2. Accordingly, the rows and columns of the adjacency matrix can have the following labels: P₁, P₂, T₁, T₂, D₁; and the values of the adjacency matrix can be assigned as follows: (P₁, T₁)=1, (P₁, D₁)=1, (P₁, P₂)=2, and (P₁, T₂)=2. It is to be appreciated that a similar schema can also be used when there are more than two products for a given plant.

In some example embodiments, the improvement model generator 106 uses an adjacency matrix (for example, as described in conjunction with FIGS. 2 and 3) to obtain one or more constraints and one or more objective functions for a given physical system. Examples of such processes are now described in more detail with reference to the following notations:
[symbol] =set of supply nodes
[symbol] =set of terminal nodes
[symbol] =set of tank nodes
[symbol] =set of process nodes
G=(V, E), where V= [symbol] ∪ [symbol] ∪ [symbol] ↔ [symbol] , and E is the set of edges in G
N⁺(i)={j∈V: (i, j)∈E}
N⁻(j)={j∈V: (i, j)∈E}
y_{i,j}∈ [symbol] =flow from node i to node j, where i∈V, j∈V
xᵢ∈ [symbol] ^{d}^{ᵢ}=control variable at i-process.
uᵢ∈ [symbol] =tank level
pᵢ∈ [symbol] =process output
fⁱ=regression model for the i-th process
y_{i,j,t}∈ [symbol] =flow from node i to node j at time t
x_{i,t}∈ [symbol] R^{d}^{ᵢ}=control variable at i-process at time t
p_{i,t}∈ [symbol] =process output at time t
gᵢ^{t}∈ [symbol] =product quality requirement at time t for the i-process
gⁱ=regression model for product quality for the i-th process
C_{i,j,t}(⋅): the flow cost function between nodes i and j at time t

According to an embodiment, the improvement model generator 106 determines constraints and objective functions over a specified time period (T) and/or sequentially for multiple time periods.

### Specified Time Period Embodiments

The improvement model generator 106 can determine the constraints and objective functions over a specified time period by applying flow conservation law at the tank and process nodes as follows:

$$\text{?} = \text{?} , ∀ i ∈ \text{?}$$

$${f}^{i} ( \{ {y}_{s , i} \text{?} ) = \text{?} , ∀ i ∈ \text{?}$$

$$\text{?} \text{indicates text missing or illegible when filed}$$

The total output at the i-th supply node is limited by the upper bound supplyᵢ:

$${\sum }_{l ∈ {N}^{+} ( i )} {y}_{i , l} \leq {supply}_{i} , i ∈ 𝒮$$

The total supply at the j-th demand node is at least demandⱼ:

$${\sum }_{s ∈ {N}^{-} ( i )} {y}_{s , j} \geq {demand}_{j} , j ∈ 𝒟$$

The total output at the i-th process node is limited by the upper bound processᵢ:

$${\sum }_{l ∈ {𝒩}^{+} ( i )} {y}_{i , l} \leq {process}_{i} , i ∈ 𝒫$$

The total input at the i-th tank node is limited by the upper bound tankⱼ:

$${\sum }_{s ∈ {𝒩}^{-} ( j )} {y}_{s , j} \leq {tank}_{j} , j ∈ 𝒯$$

The product quality q, at i-th process is constrained between bounds [qᵢ, q̅ᵢ]:

gᵢ({y_{s,i}}_{s∈N-(j)},xᵢ)=qᵢ, qᵢ≤qᵢ≤q̅ᵢ, ∀i∈

[symbol]

In some embodiments, the improvement model generator 106 can determine the improvement functions for one or more variables (for example, based on a user selection). The following equation can be applied to improve (for example, maximize) profit:

$$max \{ {\sum }_{d ∈ 𝒟} [ ( {\sum }_{i ∈ {𝒩}^{-} ( d )} {y}_{i , d} ) \times {price}_{d} ] - {\sum }_{s ∈ 𝒮} [ ( {\sum }_{j ∈ {𝒩}^{+} ( s )} {y}_{s , j} ) \times {cost}_{s} ] \}$$

where price_{d} is the price at the d-th terminal node and costs is the cost at the s-th supply node.

As another example, the following equation can be applied to reduce (for example, minimize) total flow cost:

$$min {\sum }_{( i , j ) ∈ E} {C}_{i , j} ( {y}_{i , j} )$$

### Sequential Time Period Embodiments

The improvement model generator 106 can also be configured to determine the constraints and objective functions sequentially for multiple time periods with respect to the physical system. For example, such embodiments can include processing each time period separately and/or processing the time periods jointly over the entire time horizon. In such an embodiment, the improvement model generator 106 can utilize the following equations to determine flow conservation:

$${\sum }_{l ∈ {𝒩}^{+} ( i )} {y}_{i , l , t} = {\sum }_{s ∈ {𝒩}^{-} ( j )} {y}_{s , i , t} , ∀ i ∈ 𝒯 , t = 1 , … , T$$

$${f}^{i} ( {\{ {y}_{s , i , t} \}}_{s ∈ {N}^{-} ( j )} , {x}_{i , t} ) = {\sum }_{l ∈ {N}^{+} ( i )} {y}_{i , l , t}$$

where fⁱ is the regression model for the i-th process, ∀i∈P, t=1, . . . , T. The index t for any variable and parameter is used to model the value at the t-th period.

Supply capacity, target demand, and process capacity can each be determined by treating time periods t=1, . . . , T separately as shown in the following equations, for example:
Supply capacity (each time period separately):

$${\sum }_{l ∈ {𝒩}^{+} ( i )} {y}_{i , l , t} \leq {supply}_{i}^{l} , i ∈ 𝒮 , t = 1 , … , T$$

Target Demand (each time period separately):

$${\sum }_{s ∈ {𝒩}^{-} ( j )} {y}_{s , j , t} \geq {demand}_{j}^{t} , j ∈ 𝒟 , t = 1 , … , T$$

Process Capacity (each time period separately):

$${\sum }_{l ∈ {𝒩}^{+} ( i )} {y}_{i , l , t} \leq {process}_{i}^{t} , i ∈ 𝒫 , t = 1 , … , T$$

Additionally, or alternatively, supply capacity, target demand, and process capacity can each be determined over the entire time horizon, as shown in the following equations:
Supply capacity (jointly over the entire time horizon):

$${\sum }_{t = 1}^{T} {\sum }_{l ∈ {𝒩}^{+} ( i )} {y}_{i , l , t} \leq {supply}_{i} , i ∈ 𝒮$$

Target Demand (jointly over the entire time horizon):

$${\sum }_{t = 1}^{T} {\sum }_{s ∈ {𝒩}^{-} ( j )} {y}_{s , j , t} \geq {demand}_{j} , j ∈ 𝒟$$

Process Capacity (jointly over the entire time horizon):

$${\sum }_{t = 1}^{T} {\sum }_{l ∈ {𝒩}^{+} ( i )} {y}_{i , l , t} \leq {process}_{i} , i ∈ 𝒫$$

In such embodiments, the tank level u_{i,t} is within a range [uᵢ, ūᵢ]:

$${u}_{i , t} = {\sum }_{s ∈ {𝒩}^{-} ( j )} {y}_{s , j , t} - {\sum }_{l ∈ {𝒩}^{+} ( i )} {y}_{i , l , t} + {u}_{i , t - 1} , i ∈ 𝒯 , t = 1 , … , T$$

$${\underline{u}}_{i} \leq {u}_{i , t} \leq {\overline{u}}_{i} , i ∈ 𝒯 , t = 1 , … , T$$

where u_{i,0} is the initial tank level.

Ramp rate constraints to model the allowed percentage change for each variable can be determined as follows:

$$\vert {( {x}_{i , t} )}_{k} - {( {x}_{i , t - 1} )}_{k} \vert \leq α \cdot {( {x}_{i , t} )}_{k} , k = 1 , … , {d}_{i} ,$$

$$i ∈ 𝒫 , t = 1 , … , T$$

$$\vert {u}_{i , t} - {u}_{i , t - 1} \vert \leq β \cdot {u}_{i , t} , i ∈ 𝒯 , t = 1 , … , T$$

$${p}_{i , t} = {\sum }_{l ∈ {𝒩}^{+} ( i )} {y}_{i , l , t} , i ∈ 𝒫 , t = 1 , … , T$$

$$\vert {p}_{i , t} - {p}_{i , t - 1} \vert \leq γ \cdot {p}_{i , t} , i ∈ 𝒫 , t = 1 , … , T$$

where α, β, γ are model parameters, which are selected by a user, for example, α=0.2, β=0.5, γ=0.4.

The product quality gᵢ^{t}, at the i-th process is constrained between bounds [qᵢ, q̅ᵢ], as shown below:

gⁱ({ [symbol] [symbol] }_{s∈N-(j)},x_{i,t})=qᵢ^{l}

qᵢ≤qᵢ^{l}≤q̅ᵢ, ∀i∈ [symbol] , t=1, . . . ,T.

The output for multiple products can be expressed as:

$${f}_{k}^{i} \{ {\{ {y}_{s , i , t} \}}_{s ∈ {𝒩}^{-} ( j )} , {x}_{i , t} ) = {\sum }_{i ∈ {𝒩}^{+} ( i ) , {a}_{n} = k} {y}_{i , l , t} ,$$

$$∀ i ∈ 𝒫 , t = 1 , … , T , k - th product$$

The improvement functions can be determined in a similar manner as described above with respect to the single time period embodiments. As non-limiting examples, the following improvement functions can be to maximize profit and minimize total cost, respectively:

$$max {\sum }_{t = 1}^{T} \{ {\sum }_{d ∈ 𝒟} [ ( {\sum }_{i ∈ {𝒩}^{-} ( d )} {y}_{i , d , t} ) \times {price}_{d}^{t} ] \} - {\sum }_{t = 1}^{T} \{ {\sum }_{s ∈ 𝒮} [ ( {\sum }_{j ∈ {𝒩}^{+} ( s )} {y}_{s , j , , t} ) \times {cost}_{s}^{t} ] \}$$

$$min {\sum }_{t = 1}^{T} {\sum }_{( i , j ) ∈ A} {C}_{i , j , t} ( {y}_{i , j , t} )$$

In some embodiments, the solver 112 can solve the generated improvement model 110, thereby generating the predicted set points 114. The solver 112 may utilize different algorithms depending on the type of regression model generated for each node. As non-limiting examples, the solver 112 can implement a mixed-integer linear program (MILP) for piecewise linear regression models, and a mixed integer non-linear program (MINLP) when the regression models are non-linear. These are merely non-limiting examples of processes that can be implemented by the solver 112, and those skilled in the art will appreciate that other processes can also be used to solve the improvement model. The quality metric calculator 116 provides a metric that quantifies the quality of the solution (for example, the predicted set points 114) of the solver 112. More specifically, given a historical dataset Dₜ{((xᵢ, yᵢ), . . . , (xₙ, yₙ)}, where yᵢ=f(xᵢ) and suggested setpoint \hat{x}, the quality metric calculator 116 attempts to estimate the improvement in the value of the best observed point over N observations: f(\tilde{x})−fₙ*, where fₙ*=max_{i≤N}f(xᵢ). Let σ be the standard deviation of the noise in the function evaluations {yᵢ}. Denote kₜ (x)=[k(x, x₁), k(x, x₂), . . . , k(x, xₜ)] for t observations, yₜ=[y₁, y₂, . . . , yₜ₋₁], where k(x,xᵢ) is a kernel function. Let K be a t×t kernel matrix with Kᵢⱼ=k(xᵢ, xⱼ). Denote Iₜ by a t×t identity matrix. In some embodiments, the kernel function can be a Matern kernel, for example.

Then, f can be modeled as probability distribution with a Gaussian process prior f(xₜ)˜GP(μl(x),σₜ²(x)), where:

μₗ(x)=kₜ(x)^{T}(K+σ²Iᵢ)⁻¹yₜ, and

σₜ²(x)=k(x,x)−kₜ(x)^{T}(K+σ²Iₜ)⁻¹yₜ.

μₜ (x) and σₜ²(x) are the mean and standard deviation of the posterior distribution function.

The decision quality for x is measured by the expected improvement to the upper confidence bound: q(x)=μₜ(x)+τσₜ(x) for some model parameter τ (for example, τ=0.5). In some embodiments, if the expected values are too small (for example, below a threshold value), then the following regularizer can be added to the improvement model: max|x−x*|.

Although some embodiments are described herein with respect to manufacturing and process industries, this is not intended to be limiting. For example, such techniques can be broadly applied to other systems having complex processes that can be represented as flow diagrams, where each process includes a set of inputs and outputs, as will be apparent to those skilled in the art.

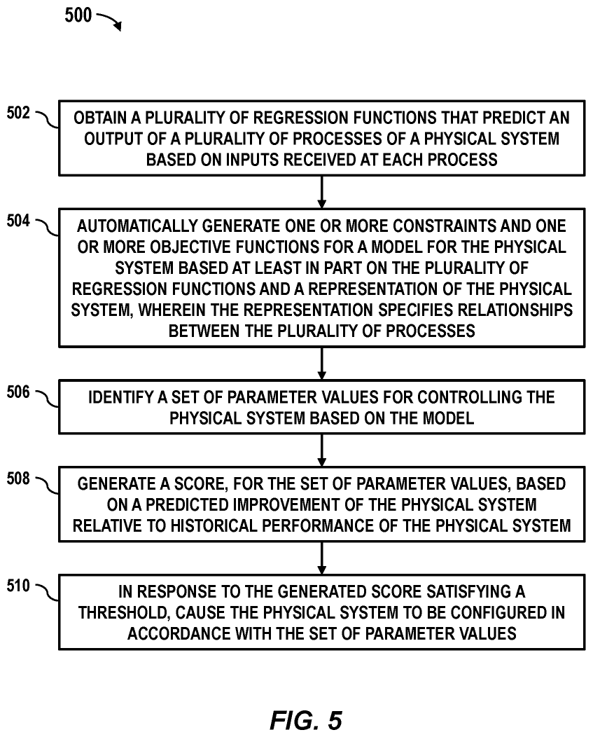

FIG. 5 is a flow diagram illustrating a process 500 for a decision-improvement framework in accordance with exemplary embodiments.

Step 502 includes obtaining a plurality of regression functions that predict an output of a plurality of processes of a physical system based on inputs received at each process. Step 504 includes automatically generating one or more constraints and one or more objective functions for a model for the physical system based at least in part on the plurality of regression functions and a representation of the physical system, where the representation specifies relationships between at least a portion of the plurality of processes. Step 506 includes identifying a set of parameter values for controlling the physical system based on the model. Step 508 includes generating a score, for the set of parameter values, based on a predicted improvement of the physical system relative to historical performance of the physical system. Step 510 includes in response to the generated score satisfying a threshold, causing the physical system to be configured in accordance with the set of parameter values.

The regression functions may be automatically generated and obtained from a machine learning framework. The process depicted in FIG. 5 may include a step of generating a feedback signal, based on the generated score, to update at least one of the model and the machine learning framework. The process in FIG. 5 may include a step of: in response to the generated score not satisfying the threshold, identify a new set of parameter values based on the updated at least one of the model and the machine learning framework. The representation may include a directed graph, where the plurality of processes of the physical system is represented as nodes in the directed graph, and where the relationships between at least a portion of the plurality of processes are represented as edges in the directed graph. The directed graph may include one or more cycles. The physical system may correspond to a manufacturing plant that produces one or more products. The set of parameter values may specify a configuration for each of the plurality of processes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as decision-improvement framework code 626 (also referred to as “block 626”). In addition to block 626, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 626, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

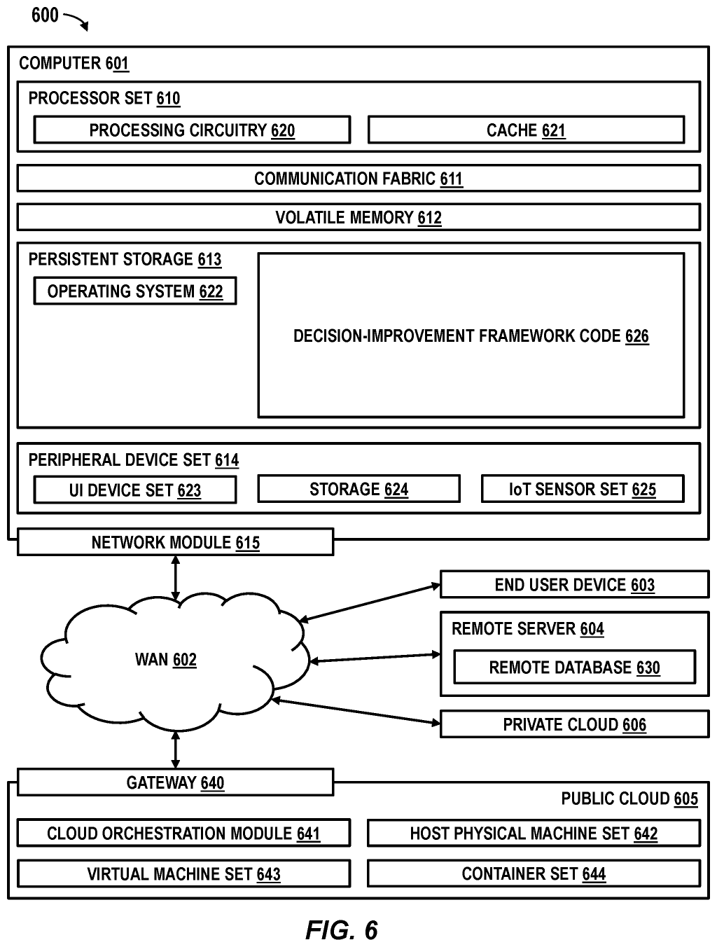

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 626 in persistent storage 613.

Communication fabric 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 626 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory configured to store program instructions;
a processor operatively coupled to the memory to execute the program instructions to:
obtain a plurality of regression functions that predict an output of a plurality of processes of a physical system based on inputs received at each process;
automatically generate one or more constraints and one or more objective functions for a model for the physical system based at least in part on the plurality of regression functions and a representation of the physical system, wherein the representation specifies relationships between at least a portion of the plurality of processes;
identify a set of parameter values for controlling the physical system based on the model;
generate a score, for the set of parameter values, based on a predicted improvement of the physical system relative to historical performance of the physical system; and
in response to the generated score satisfying a threshold, cause the physical system to be configured in accordance with the set of parameter values.

2. The system of claim 1, wherein the regression functions are automatically generated and obtained from a machine learning framework.

3. The system of claim 2, wherein the processor is operatively coupled to the memory to execute the program instructions to:
generate a feedback signal, based on the generated score, to update at least one of the model and the machine learning framework.

4. The system of claim 3, wherein the processor is operatively coupled to the memory to execute the program instructions to:
in response to the generated score not satisfying the threshold, identify a new set of parameter values based on the updated at least one of the model and the machine learning framework.

5. The system of claim 1, wherein the representation comprises a directed graph, wherein the plurality of processes of the physical system is represented as nodes in the directed graph, and wherein the relationships between at least a portion of the plurality of processes are represented as edges in the directed graph.

6. The system of claim 5, wherein the directed graph comprises one or more cycles.

7. The system of claim 1, wherein the physical system corresponds to a manufacturing plant that produces one or more products.

8. The system of claim 1, wherein the set of parameter values specify a configuration for each of the plurality of processes.

9. A computer program product comprising a computer readable storage medium having program instructions embodied therewith, the program instructions executable by a computing device to cause the computing device to:
obtain a plurality of regression functions that predict an output of a plurality of processes of a physical system based on inputs received at each process;
automatically generate one or more constraints and one or more objective functions for a model for the physical system based at least in part on the plurality of regression functions and a representation of the physical system, wherein the representation specifies relationships between at least a portion of the plurality of processes;
identify a set of parameter values for controlling the physical system based on the model;
generate a score, for the set of parameter values, based on a predicted improvement of the physical system relative to historical performance of the physical system; and
in response to the generated score satisfying a threshold, cause the physical system to be configured in accordance with the set of parameter values.

10. The computer program product of claim 9, wherein the regression functions are automatically generated and obtained from a machine learning framework.

11. The computer program product of claim 10, wherein the program instructions executable by a computing device cause the computing device to:
generate a feedback signal, based on the generated score, to update at least one of the model and the machine learning framework.

12. The computer program product of claim 11, wherein the program instructions executable by a computing device cause the computing device to:
in response to the generated score not satisfying the threshold, identify a new set of parameter values based on the updated at least one of the model and the machine learning framework.

13. The computer program product of claim 9, wherein the representation comprises a directed graph, wherein the plurality of processes of the physical system is represented as nodes in the directed graph, and wherein the relationships between at least a portion of the plurality of processes are represented as edges in the directed graph.

14. The computer program product of claim 13, wherein the directed graph comprises one or more cycles.

15. The computer program product of claim 9, wherein the physical system corresponds to a manufacturing plant that produces one or more products.

16. A computer-implemented method comprising:
obtaining a plurality of regression functions that predict an output of a plurality of processes of a physical system based on inputs received at each process;
automatically generating one or more constraints and one or more objective functions for a model for the physical system based at least in part on the plurality of regression functions and a representation of the physical system, wherein the representation specifies relationships between at least a portion of the plurality of processes;
identifying a set of parameter values for controlling the physical system based on the model;
generating a score, for the set of parameter values, based on a predicted improvement of the physical system relative to historical performance of the physical system; and
in response to the generated score satisfying a threshold, causing the physical system to be configured in accordance with the set of parameter values.

17. The computer-implemented method of claim 16, wherein the regression functions are automatically generated and obtained from a machine learning framework.

18. The computer-implemented method of claim 17, comprising:
generating a feedback signal, based on the generated score, to update at least one of the model and the machine learning framework.

19. The computer-implemented method of claim 18, comprising:
in response to the generated score not satisfying the threshold, identifying a new set of parameter values based on the updated at least one of the model and the machine learning framework.

20. The computer-implemented method of claim 16, wherein the representation comprises a directed graph, wherein the plurality of processes of the physical system is represented as nodes in the directed graph, and wherein the relationships between at least a portion of the plurality of processes are represented as edges in the directed graph.
